(19) United States
(12) Patent Application Publication
(10) Pub. No.: US 2002/0079672 A1
(43) Pub. Date: Jun. 27, 2002

(54) Interchangeable ball hitch

(76) Inventors: Richard W. McCoy, Granger, IN (US); Chad A. McCoige, Orlando, FL (US)

Correspondence Address: KING & SCHICKLI, PLLC, 247 NORTH BROADWAY, LEXINGTON, KY, 40507, US

(21) Appl. No.: 10/004,957

(22) Filed: Dec. 4, 2001

Related U.S. Application Data
(63) Continuation of application No. 09/479,152, filed on Jan. 7, 2000, now abandoned.
(60) Provisional application No. 60/117,544, filed on Jan. 28, 1999.

(51) Int. Cl. B60D 1/00

(52) U.S. Cl. 280/511

(57) ABSTRACT

An interchangeable ball hitch includes a post with a threaded stem and a tapered shank, a ball including a tapered bore adapted for receipt on the tapered shank and a cap for engaging a locking track carried on the tapered shank and securing the ball to the post.

This application claims the benefit of U.S. Provisional Application No. 60/117,544 filed Jan. 28, 1999 and is a continuation of U.S. patent application Ser. No. 09/479,152 filed Jan. 7, 2000.

### TECHNICAL FIELD

The present invention relates generally to the towing field and more particularly to an interchangeable ball hitch that may be conveniently utilized to quickly and efficiently tow trailers requiring hitch balls of various diameter.

### BACKGROUND OF THE INVENTION

The use of a ball joint coupling comprising a hitch ball and cooperating socket assembly in order to tow a trailer behind a towing vehicle is well known in the art. Such an arrangement provides the necessary freedom of movement to allow a trailer to track smoothly behind the towing vehicle and this is advantageously accomplished while also providing a dependable connection.

Over the years hitch balls of various diameters have been used for this purpose and several industry standard sizes (e.g. 1 ⅞″, 2″, 2 ¼″, 2 5/16″) are now in frequent use. As a result, it is not uncommon for a single towing vehicle to be used to tow various trailers where those trailers are equipped with socket assemblies adapted for operative connection with hitch balls of different diameters. Thus, a need is identified for a ball hitch allowing easy and convenient interchange of hitch balls of different diameter so that the hitch of the towing vehicle may be tailored to fit the socket assembly on the trailer to be towed and thereby meet application needs.

Toward this end, a number of approaches have been proposed in the past. Representative of the interchangeable ball hitch art are U.S. Pat. Nos. 4,433,854 to Smith, 4,522,421 to Vance and 4,938,496 to Thomas et al. Generally, the prior art approaches are relatively complicated structures having many parts. As a consequence, they are not only expensive to produce but also suffer from an increased likelihood of failure. In addition, many require special tools in order to allow the hitch ball to be changed. If these tools are lost or misplaced, significant inconvenience results. Accordingly, it is apparent that a need exists for an improved interchangeable ball hitch overcoming the various limitations and disadvantages characteristic of the prior art.

### SUMMARY OF THE INVENTION

Accordingly, it is a primary object of the present invention to provide an interchangeable ball hitch of relatively simple and inexpensive yet durable construction providing convenient interchangeability of balls of various diameter over a long and dependable service life.

An additional object of the present invention is providing an interchangeable ball hitch wherein balls of various diameter may be securely held on a cooperating post while allowing relative rotation between the ball and post for best possible towing performance and efficiency.

Still another object of the present invention is providing an interchangeable ball hitch wherein the ball may be quickly and conveniently changed as required to meet the needs of the vehicle operator in towing trailers of various hitch arrangements without the need of special tools.

Additional objects, advantages and other novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the foregoing and other objects, and in accordance with the purposes of the present invention as described herein, an improved interchangeable ball hitch is provided. The interchangeable ball hitch includes a post having a mounting stem and a tapered shank. Preferably, the tapered shank carries a locking track and cavity.

A ball including a tapered bore is received on the tapered shank. Additionally, a cap is provided for engaging the locking track and securing the ball to the post. A detent incorporating a spring loaded pin is received in the cavity for engaging the cap and securing the cap in place in its ball securing position.

Still more specifically describing the invention, the mounting stem is threaded. The mounting stem is inserted through a cooperating opening in the tow bar or ball mount of the hitch and may be secured in place by means of an appropriate fastener of a type known in the art such as a locking nut.

In addition, in the most preferred embodiment the cap includes a pair of opposed guide rails for engaging the locking track. Additionally, the cap includes a notch which receives the locking pin when the cap is properly seated on the locking track. This advantageously insures that the cap is positively held in the desired position for securing the ball to the post. Thus, a double lock of highest integrity is provided.

In accordance with yet another aspect of the present invention, a method is provided for securing a hitch ball to a post. The method includes the steps of (1) placing the hitch ball on the post and (2) sliding a cap over the hitch ball. More specifically, one slides the cap in a direction substantially perpendicular to the longitudinal axis of the post until the cap engages the post and secures the hitch ball to the post. The method may be further defined as including the step of providing a track on the post for engagement with the cap.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention and together with the description serves to explain the principles of the invention. In the drawing:

FIG. 1 is an exploded perspective view of the interchangeable ball hitch of the present invention;

FIG. 2 is a side elevational view of the ball hitch of FIG. 1 shown secured to a tow bar;

FIG. 3 is a cross sectional view taken along line 3-3 of FIG. 2; and

FIG. 4 is a detailed bottom plan view of the cap used to secure the ball to the post.

Reference will now be made in detail to the present preferred embodiment of the invention, an example of which is illustrated in the accompanying drawing.

### DETAILED DESCRIPTION OF THE INVENTION

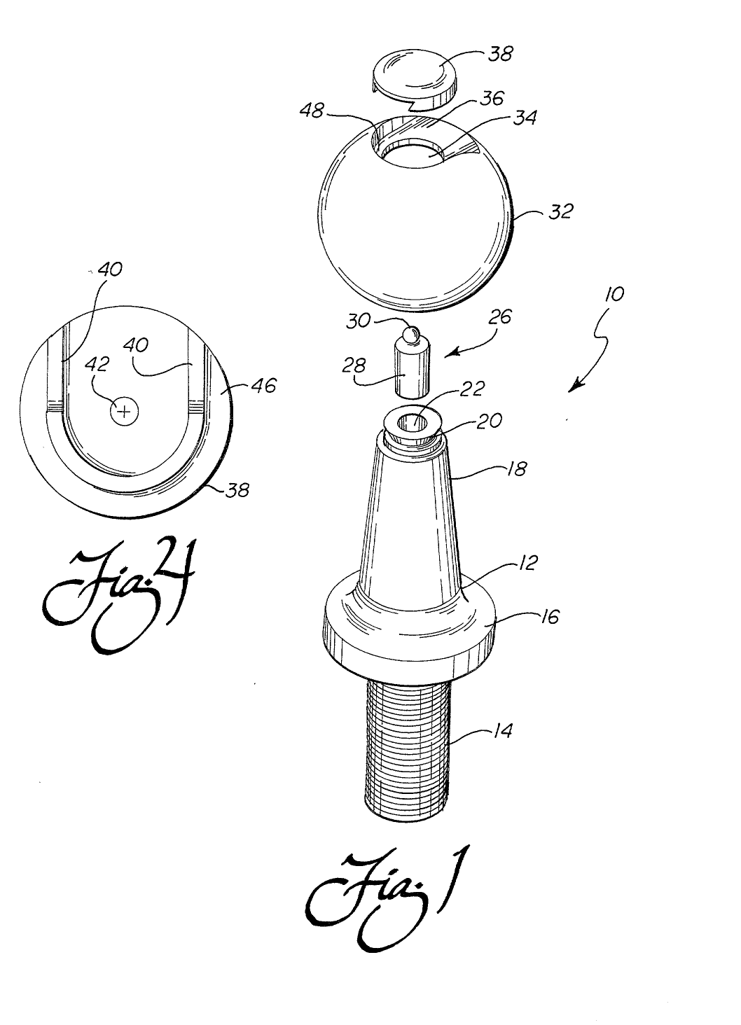

Reference is now made to FIGS. 1-4 showing the interchange-able ball hitch 10 of the present invention. The interchangeable ball hitch 10 includes a post 12 having a threaded mounting stem 14, an enlarged base collar 16 and a tapered shank 18. An annular locking track 20, such as a dove tail channel, is provided at the top of the tapered shank 18. The annular locking track 20 extends continuously around the shank 18. A fastener such as a locking nut 19 may be tightened on the threaded mounting stem 14 in order to secure the hitch ball to a tow bar T or other support structure such as a ball mount of a weight distributing hitch.

Additionally, a cavity 22 is formed in the axial end of the tapered shank 18 remote from the base collar 16. A detent, generally designated by the reference numeral 26 is secured in the cavity 22. The detent 26 includes a housing 28 that conforms in size and shape to the cavity 22 so as to be received therein. The housing 28 holds a spring loaded pin 30 the function of which will be described in greater detail below. Preferably, the detent 26 is cinched in place for a positive frictional fit. In one alternative embodiment, the housing 28 and the sidewall of the cavity 22 may be threaded for screw like engagement. Of course, other appropriate mounting arrangements could be utilized.

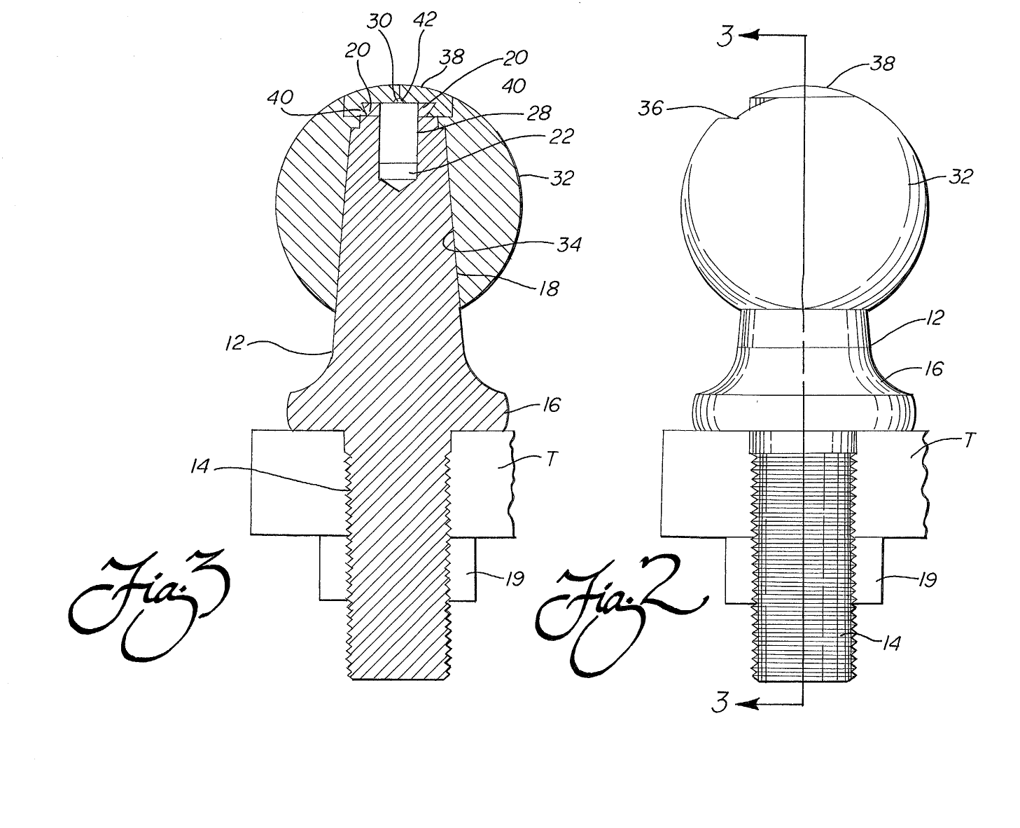

The interchangeable ball hitch 10 further includes a hitch ball 32. As best shown in FIG. 3, hitch ball 32 includes a tapered bore 34 which matches the taper of the tapered shank 18. Accordingly, hitch ball 32 may be received on and secured to the tapered shank 18.

As best shown in FIGS. 1 and 3, the hitch ball 32 also includes a slot 36 which communicates with the tapered bore 34. When the hitch ball 32 is properly seated on the tapered shank 18, slot 36 is aligned with the locking track 20 at the top of the post 12. A unitary locking cap 38 is then secured in position on the locking track 20 to hold the hitch ball 32 to the post 12 in a manner described in greater detail below.

As best shown in FIG. 4, cap 38 includes a pair of opposed guide rails 40 and a notch 42. The guide rails 40 are sized, shaped and spaced to engage in the dove tail like channel of the locking track 20. Accordingly, the cap 38 is secured in position by sliding the cap laterally through the slot 36 in a direction substantially perpendicular to the longitudinal axis of the post 12 and engaging the guide rails 40 in the locking track 20. As a result, the hitch ball 32 is effectively captured on the tapered shank 18 by the overlying cap 38. This is because the outer margin or shoulder 46 of the cap 38 engages the shoulder 48 of the ball 32.

When the cap 38 is fully and properly seated in position to secure the hitch ball 32 to the post 12, the spring loaded locking pin 30 of the detent 26 projects into and is received in the notch 42 on the underside of the cap 38. Thus, the pin 30 provides a positive locking force to secure the cap 38 in position. This structural arrangement provides a double lock of high integrity. Specifically, the guide rails 40 lock in the locking track 20 and the pin 30 locks in the notch 42.

As a result of the present structural arrangement, hitch ball 32 is not only prevented from moving along the longitudinal axis of the post 12 but is also free to rotate relative to the tapered shank 18 of the post 12. This is because the guide rails 40 on the cap 38 freely orbit around the annular locking track 20 while maintaining a secure connection. Advantageously, towing efficiency is increased as the free rotation of the hitch ball 32 on the post 12 minimizes the friction that must be overcome during towing as the vehicle and trailer turn relative to each other. Further, relative free rotation of the hitch ball 32 on the shank 18 prevents any inadvertent loosening of the locking nut 19.

In addition, it should be appreciated that the hitch ball 32 is securely held on the post 12. Specifically, the cap 38 may only be removed when properly aligned with the slot 36 in the hitch ball 32. In all other positions, the upper margin of the hitch ball 32 which projects above the shoulder 48 functions to block cap removal. Further, even when the cap is properly aligned with the slot 36, the spring loaded locking pin 30 of detent 26 secured in the post 12 seats in the notch 42 of the cap 38 so as to secure the cap in position.

Of course, as noted above, a single vehicle is often used for multiple towing applications. Each trailer towed may include a socket for receiving a different size hitch ball. Advantageously, the present invention allows one to quickly and easily match the hitch ball 32 to the size of hitch ball socket of the trailer to allow towing. More specifically, a hitch ball 32 of substantially any standard diameter may be secured to the post 12. More specifically, each hitch ball 32 is machined to incorporate a tapered bore 34 to match the tapered shank 18 of the ball hitch 10. In this way, a hitch ball 32 of substantially any desired diameter may be properly seated on the tapered shank 18 so that the slot 36 in the hitch ball is properly aligned with the locking track 20 of the post 12 to allow the locking cap 38 to be secured in place in the manner previously described. Advantageously, this procedure may be performed conveniently and efficiently in a short amount of time without any special tools.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, the hitch ball 32 may be fixed to the post 12 so as to prevent relative rotation therebetween, if desired. This may be accomplished through use of a polygonal shank and mating polygonal hitch ball bore or by some other means. Further, the cap 3 8 may either rotate with the hitch ball 32 or the cap may be keyed to the post 12. Additionally, alternative configurations of the guide rails 40 and locking track 20 may be utilized. Any shape or configuration of cooperating male and female components could be adopted so as to provide an appropriate interlocking of components (e.g. T-shaped, L-shaped). Further, the male and female components could be reversed. Thus, the track could be provided in the cap 38 and the rail could be provided on the shank 18.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

In the claims

1. An interchangeable ball hitch, comprising:
a post including a mounting stem and a tapered shank, said tapered shank carrying a locking track;
a ball including a tapered bore received on said tapered shank; and
a unitary locking cap for directly engaging said locking track and securing said ball to said post.

2. An interchangeable ball hitch, comprising:
a post including a mounting stem and a shank, said shank carrying a locking track and a cavity;
a ball including a bore received on said shank;
a unitary locking cap for directly engaging said locking track and securing said ball to said post; and
a detent received in said cavity for engaging said cap and securing said cap in place.

3. An interchangeable ball hitch, comprising:
a post including a mounting stem and a tapered shank, said tapered shank carrying a locking track and a cavity;
a ball including a tapered bore received on said tapered shank;
a unitary locking cap for directly engaging said locking track and securing said ball to said post; and
a detent received in said cavity for engaging said cap and securing said cap in place.

4. The interchangeable ball hitch of claim 3, wherein said mounting stem is threaded.

5. The interchangeable ball hitch of claim 4, further including a fastener for engaging said mounting stem and securing said interchangeable ball hitch to a support structure of a hitch assembly.

6. The interchangeable ball hitch of claim 3, wherein said detent includes a spring loaded pin.

7. The interchangeable ball hitch of claim 6, wherein said cap includes a pair of opposed guide rails for engaging said locking track and a notch for receiving said locking pin.

8. An interchangeable ball hitch, comprising:
a post including a mounting stem and a tapered shank;
a ball including a tapered bore received on said tapered shank;
a locking track carried on one of said shank and said cap for securing said ball to said post; and
a unitary locking cap for directly engaging said locking track and securing said ball to said post.

9. The interchangeable ball hitch of claim 8, wherein the other of said shank and said cap includes a guide rail for engaging said locking track.

10. An interchangeable ball hitch, comprising:
a post including a mounting stem, a shank and a cavity;
a ball including a bore received on said shank;
a locking track carried on one of said shank and said cap for securing said ball to said post;
a unitary locking cap for directly engaging said locking track and securing said ball to said post; and
a detent received in said cavity for engaging said cap and securing said cap in place.

11. The interchangeable ball hitch of claim 10, wherein the other of said shank and said cap includes a guide rail for engaging said locking track.

12. A method of securing a hitch ball to a post having a longitudinal axis extending in a first direction, comprising:
placing said hitch ball on said post; and
sliding a locking cap over said hitch ball in a second direction substantially perpendicular to said first direction while simultaneously engaging said post and securing said hitch ball to said post.

13. The method of claim 12, including providing a track on said post for engagement with said cap.

14. A method of securing a hitch ball to a post, comprising:
placing said hitch ball on said post;
sliding a cap over said hitch ball in a direction substantially perpendicular to a longitudinal axis of said post;
engaging a locking track on said post with said cap; and
capturing said hitch ball on said post with said cap.
